(19) United States
(12) Patent Application Publication
(10) Pub. No.: US 2018/0103570 A1
(43) Pub. Date: Apr. 19, 2018

(54) SCRAPER BLADE FOR DEPTH GAUGE WHEEL

(71) Applicant: Douglas D. Sorensen, Audubon, IA (US)

(72) Inventor: Douglas D. Sorensen, Audubon, IA (US)

(21) Appl. No.: 15/784,998

(22) Filed: Oct. 16, 2017

Related U.S. Application Data
(60) Provisional application No. 62/409,031, filed on Oct. 17, 2016.

(51) Int. Cl. A01B 15/16

(52) U.S. Cl. CPC A01B 15/16

(57) ABSTRACT

A scraper blade for a depth gauge assembly having a connecting portion attached to an elongated portion. The elongated portion has an outward concave edge that mirrors an outer surface of a depth gauge wheel.

### CROSS REFERENCE TO RELATED APPLICATION

This application claims the benefit to Provisional Application U.S. Ser. No. 62/409,031 filed on Oct. 17, 2016.

### BACKGROUND OF THE INVENTION

This invention is directed to an improved scraper blade for a depth gauge wheel of a planter.

Scrapers for depth gauge wheels are known in the art. While useful, existing scrapers have a number of problems. As examples, current scrapers are made of multiple pieces, become loose during operation, require frequent adjustment, and engage and damage the rubber depth gauge wheels. Therefore, a need exists in the art for a scraper that addresses these deficiencies.

An objective of the present invention is to provide a scraper blade made of few parts.

Another objective of the present invention is to provide a scraper blade that does not require frequent adjustment.

A still further objective of the present invention is to provide a blade scraper that does not damage a depth gauge wheel.

These and other objectives will be apparent to those having skill in the art based upon the following written description, drawings, and claims.

### SUMMARY OF THE INVENTION

A scraper blade for use with a depth gauge assembly of a row planter includes a connecting portion that has an aperture. The connecting portion is welded to an elongated portion at a generally perpendicular angle to form a T-shape.

The elongated portion has an outer concave edge that is cut to mirror an outer surface of a depth gauge wheel. The scraper blade is mounted to an outwardly extending hub on a support arm of a depth gauge assembly. The scraper blade is positioned so that a small gap is formed between the outer concave edge of the elongated portion and the outer surface of the depth gauge wheel.

### BRIEF DESCRIPTION OF THE DRAWINGS

FIG. 1 is a perspective view of a scraper blade;

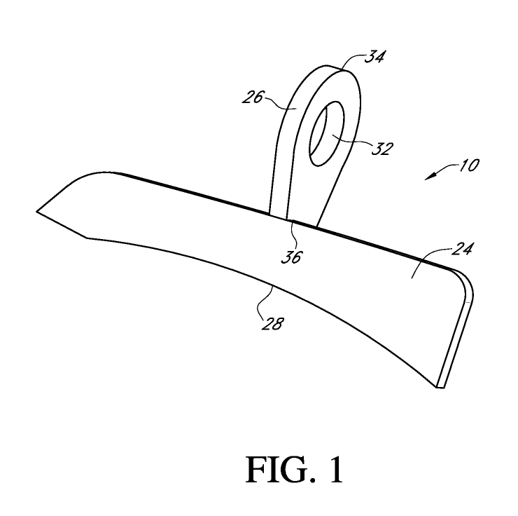

FIG. 2 is a side view of a scraper blade mounted to a depth gauge assembly; and

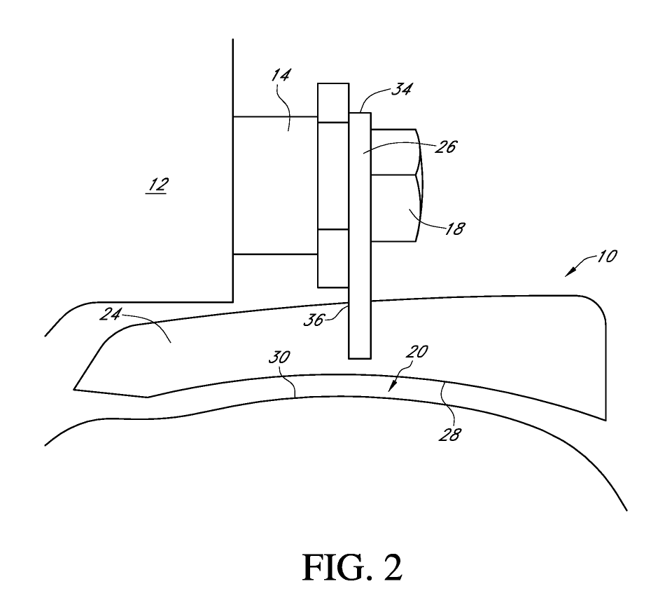

FIG. 3 is a perspective view of a scraper blade.

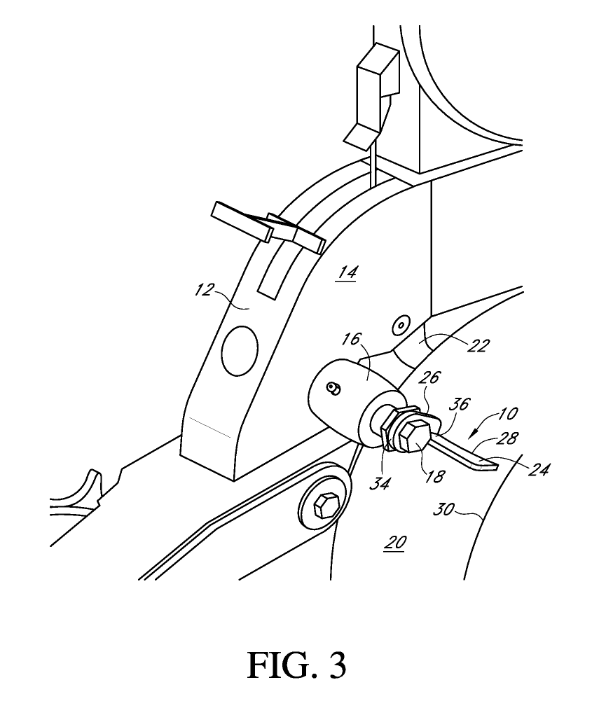

### DETAILED DESCRIPTION OF THE PREFERRED EMBODIMENT

Referring to the Figures, a scraper blade 10 is used in association with a depth gauge assembly 12 of a row unit for a planter (not shown). The depth gauge assembly 12 has a support arm 14 having a pair of outwardly extending hubs 16 that receive threaded bolts 18. A depth gauge wheel 20 is connected to the arm 14 by a bracket 22.

The scraper blade 10 has an elongated portion 24 welded to a connecting portion 26 at a generally perpendicular angle to form a T-shape. The elongated portion 24 has an outer concave edge 28 that is precisely cut to mirror the outer surface 30 of wheel 20. The connecting portion 26 has an aperture 32 at an outer end 34 and extends toward a weld point 36 on the elongated portion 24. The shape of edge 28 and the distance between the aperture 32 and the weld point 36 are determined by the make and model of the planter and depth gauge assembly. More specifically, the distance between the aperture 32 and the weld point 36 is the amount of distance needed so that edge 28 forms a small gap 38 between the edge 28 and the outer surface 30 of wheel 20.

To assemble, a pair of scraper blades 10, one for the left side and one for the right side of the row unit, are attached to gauge arm 14. To attach, bolt 18 is inserted through aperture 32 of the connecting portion 26 and then threadably inserted into hub 16. The bolt is tightened until the connecting portion 26 is firmly secured between the head 40 of bolt 18 and hub 16. Once secured the scraper blade 10 will not become loose, nor require further adjustment. Once in place the extended portion 24 is positioned to scrape or knock off lumps of damp soil or mud that have accumulated on the depth gauge wheel 20 when planting in moist soil. As a result the row unit of the planter is able to maintain a more uniform seeding depth and traverses the field in a more smooth manner. Also, because the scraper blade 10 does not engage wheel 20 the blade 10 will not damage the wheel. Accordingly, a scraper blade has been disclosed that, at the very least, meets all the stated objectives.

What is claimed is:

1. A scraper blade for a depth gauge assembly, comprising:
a connecting portion having aperture;
an elongated portion connected to the connecting portion at a weld point;
wherein the elongated portion has an outer concave edge.

2. The blade of claim 1 wherein the outer concave edge is cut to mirror an outer surface of a depth gauge wheel.

3. The blade of claim 1 wherein the elongated portion is welded to the connecting portion at a generally perpendicular angle to form a T-shape.

4. The blade of claim 1 wherein the aperture extends from an outer end on the connecting portion to a weld point on the elongated section.

5. The blade of claim 1 wherein the outer concave edge is positioned to form a gap between the outer concave edge and an outer surface of a depth gauge wheel.

6. The blade of claim 1 mounted to an outwardly extending hub of a support arm of a depth gauge assembly.
